(19) United States
(12) Patent Application Publication
(10) Pub. No.: US 2016/0193805 A1
(43) Pub. Date: Jul. 7, 2016

(54) VINYL FLOOR COVERING

(71) Applicant: BONAR B.V., Arnhem (NL)

(72) Inventor: Ype VAN DER ZIJPP, Wijhe (NL)

(73) Assignee: BONAR B.V., Arnhem (NL)

(21) Appl. No.: 14/911,210

(22) PCT Filed: Jul. 8, 2014
(86) PCT No.: PCT/EP2014/064525

§ 371 Date: Feb. 9, 2016

(30) Foreign Application Priority Data
Aug. 9, 2013 (EP) 13179825.8

(51) Int. Cl. B32B 5/02; B32B 7/02; B32B 27/30; B32B 5/26

(52) U.S. Cl. CPC B32B 5/022; B32B 5/26; B32B 7/02; B32B 27/304; B32B 2471/00; B32B 2307/736

(57) ABSTRACT

A vinyl floor covering is provided wherein the vinyl floor covering includes a carrier that includes a nonwoven layer of fibers containing thermoplastic fibers and a scrim for eliminating wrinkles in the vinyl floor covering. The scrim may include weft threads configured to match the shrinkage in the cross machine direction of the nonwoven layer of fibers including thermoplastic fibers for preventing the formation of printing errors and/or surface irregularities in the vinyl floor covering.

### BACKGROUND

The disclosure pertains to vinyl floor coverings.

Vinyl floor coverings basically can be prepared by two different methods. The first method comprises the steps of supplying a calendered coherent sheet of PVC having a controlled thickness, which is subsequently laminated onto a backing material, as, for example, disclosed by US 2008/0193897 A1. As the calendered sheet of PVC is already a coherent material, the backing material is generally not subjected to treatments at elevated temperatures and the tensions applied to the backing are generally relatively low.

The second method of preparing vinyl floor coverings comprises the steps of supplying a PVC plastisol, and impregnating the PVC plastisol into a carrier material. After impregnation of the carrier material, the PVC plastisol is gelated at elevated temperature to obtain a coherent layer of PVC.

For example, cushioned vinyl floor covering may be made by applying several PVC based layers on a carrier material, each layer of PVC having its own function.

The carrier is impregnated with a layer of PVC plastisol, which is gelated at elevated temperature, generally in the range of 140° C. to 170° C., while the impregnated carrier is in contact with the surface of a hot (metal) roller. Subsequently, a foaming layer of PVC plastisol comprising a blowing agent is coated on the gelated impregnation layer, which is then also gelated at elevated temperature.

Desired ink patterns are applied onto the gelated foaming layer using printing units. On top of this printing layer a layer of clear, transparent PVC plastisol is applied as a wear layer, which again is gelated at elevated temperature. At the bottom side a backing layer of foamable PVC plastisol comprising a relatively large amount of blowing agent may be applied. The blowing agents in the PVC plastisol of the foaming layer and the backing layer are activated In a curing step at a temperature above the gelation temperatures, generally in the range of 170° C. to 230° C., to foam and to cure the PVC in the foaming layer and in the backing layer in order to obtain the cushioned vinyl floor covering.

Cushioned vinyl floor covering comprising a nonwoven carrier composed of thermoplastic fibers is known, for example from FR2013722 A1 and WO2005/118947 A1. Such a nonwoven carrier composed of thermoplastic fibers provides better tear resistance and flexibility to the cushioned vinyl floor covering as compared to non-thermoplastic fiber based carriers.

FR2013722 A1 discloses a nonwoven mat made from nylon (polyamide) filaments with a vinyl chloride coating usable as floor covering. The nonwoven mat is bonded by hydrogen bonds at the points of intersection of the filaments.

WO2005/118947 A1 discloses a nonwoven carrier wherein the nonwoven is made from different polymers and the nonwoven carrier is thermally bonded by a polymer originating from the filaments comprised in the nonwoven carrier.

U.S. Pat. No. 3,968,290 A discloses PVC flooring comprising a lofty, resilient backing web, which is only partially Impregnated with PVC.

CN201011108 Y discloses a PVC sport floor comprising a carrier composed of a woven glass scrim and a polyester staple fiber nonwoven bonded to the woven glass scrim by an adhesive layer.

However, if is observed that vinyl floor coverings comprising a nonwoven carrier composed of thermoplastic fibers may exhibit wrinkles during processing in the vinyl floor covering manufacturing process, which extend essentially in the machine direction of the vinyl floor covering, which results in low quality vinyl floor covering or even in rejected product, i.e., waste material, depending on the quantity and magnitude of the wrinkles.

### BRIEF SUMMARY

It is an object of the disclosure to provide a vinyl floor covering comprising a carrier material comprising a nonwoven layer containing thermoplastic fibers, which exhibits no, or at least less surface defects, which may include wrinkles or printing defects resulting from an uneven surface.

### BRIEF DESCRIPTION OF THE DRAWINGS

FIG. 1 schematically shows buckling of the weft threads of the scrim during gelation of the PVC plastisol in the impregnation layer, resulting in an uneven surface of the gelated impregnation layer, especially when buckling of the weft threads occurs out of the plane forming a surface of the carrier.

### DETAILED DESCRIPTION

The presence of a scrim in the carrier for the vinyl floor covering prevents, or at least reduces, the formation of wrinkles, which extend in the machine direction in the vinyl floor covering. It is believed that the presence of the scrim reduces the strain in the machine direction in the nonwoven layer of fibers comprising thermoplastic fibers of the carrier, resulting from the high tensions encountered in the vinyl floor covering manufacturing process. As the scrim reduces the strain in the machine direction, the nonwoven layer of fibers will exhibit less contraction and/or shrinkage in the cross machine direction. Wrinkles in the nonwoven layer of fibers are believed to occur due to local variations in stress-strain behavior at non-uniformities in the mass regularity of the nonwoven layer of fibers.

In an embodiment, the vinyl floor covering is a cushioned vinyl floor covering.

Within the scope of the present disclosure, the term carrier or carrier material is understood to mean a material that is suitable to be impregnated with a PVC plastisol.

The term backing or backing material is understood to mean a material that is suitable to be laminated with a calendered coherent sheet of PVC. The backing is adhered to the sheet of PVC.

A general demand to carriers for (cushioned) vinyl floor coverings is sufficient surface regularity, i.e., a sufficiently even thickness over the surface of the carrier, necessary to apply the impregnation layer regularly over the full width of the carrier. Furthermore, sufficient structure openness is needed for even penetration of the PVC plastisol through the carrier in order to have sufficient delamination strength between the top layers and the foamed backing layer. On the other hand, the structure of the carrier material should not be too open in order to prevent the PVC plastisol to fall through the carrier before the PVC has been gelated into a coherent PVC material.

In one embodiment of the vinyl floor covering, the nonwoven layer of fibers and the scrim of the carrier may be supplied in the vinyl floor covering manufacturing process as two separate layers, as long as the tensions in the vinyl floor covering manufacturing process are applied to ail the layers of the carrier.

The carrier may comprise one or more further layers, each layer selected from a nonwoven layer of fibers and/or a scrim, for example, to improve the mass uniformity of the carrier and/or to further reduce the shrinkage and/or contraction in the cross machine direction of the nonwoven layer of fibers comprised in the carrier.

Preferably, the nonwoven layer of fibers and the scrim, and optional further layers, are supplied as a single, integrated carrier wherein the scrim and the nonwoven layer of fibers (and optional further layers) are connected to each other to form an integrated carrier. Connection of the scrim and the nonwoven layer of fibers to each other can be performed by any known suitable process, such as, for example, by use of an adhesive such as a glue and/or a hot melt, or by thermal bonding, such as hot air bonding or calendaring, and/or by mechanical bonding processes, such as stitching, mechanical needling and/or fluid entanglement, for example, hydroentanglement. The term “connected to” is to be understood to also include the situation wherein the scrim is located in between (embedded) two nonwoven layers of fibers wherein the nonwoven layers of fibers are bonded to each other through the openings in the scrim by any suitable process, thus integrating the warp and weft threads of the scrim by encapsulation by the fibers of the two nonwoven layers of fibers bonded to each other.

Preferably, the nonwoven layer of fibers and the scrim of the integrated carrier are connected to each other by thermal bonding and/or by mechanical bonding processes, such that the application of an additional adhesive is not required, and an adhesive free carrier is obtained. Applying an adhesive requires additional equipment and additional raw materials.

More preferably, the nonwoven layer of fibers and the scrim of the integrated carrier are connected to each other by thermal bonding, such that the application of mechanical bonding processes is not required. Mechanical bonding processes inherently possess a risk of damaging the scrim. Preferably, the nonwoven layer of fibers and the scrim of the integrated carrier are connected to each other by thermal bonding only.

In an embodiment, the scrim comprised in the carrier comprises high modulus yarns as warp threads, such as, for example, glass yarns, aramid yarns or carbon yarns and/or other high modulus yarns or any combination thereof, which are capable of withstanding the temperatures encountered in the vinyl floor covering manufacturing process. Preferably, the scrim comprises glass yarns as warp threads. Preferably, all warp threads in the scrim are high modulus yarns, more preferably, all warp threads in the scrim are glass yarns. The high modulus yarns have a modulus of al least 25 GPa, preferably at least 40 GPa, more preferably at least 50 GPa, most preferably at least 75 GPa.

The type and amount of high modulus yarns comprised as warp threads in the scrim is selected such that the modulus of the scrim is at least 50 N/5 cm as determined as the load at specified elongation of 2% (LASE2%) in accordance with EN29073-3 (August 1992) with a clamp speed of 200 mm/mm. Preferably, the modulus of the scrim is at least 100 N/5 cm, more preferably at least 200 N/5 cm, most preferably at feast 250 N/5 cm.

In an embodiment, the scrim comprises high modulus yarns as weft threads, such as, for example glass yarns, aramid yarns or carbon yarns and/or other high modulus yarns or any combination thereof, which are capable to withstand the temperatures encountered in the cushioned vinyl floor covering manufacturing process. All weft threads in the scrim may be high modulus yarns, such as glass yarns.

Within the scope of the present disclosure, if is understood that the term fibers refers to both staple fibers and filaments. Staple fibers are fibers that have a specified, relatively short length in the range of 2 to 200 mm. Filaments are fibers having a length of more than 200 mm, preferably more than 500 mm, more preferably more than 1000 mm. Filaments may even be virtually endless, for example when formed by continuous extrusion and spinning of a filament through a spinning hole in a spinneret.

The fibers may have any cross sectional shape, including round, trilobal, multilobal or rectangular, the latter exhibiting a width and a height wherein the width may be considerably larger than the height, so that the fiber in this embodiment is a tape. Furthermore, said fibers may be mono-component, bicomponent or even multi-component fibers.

In an embodiment, the fibers in the nonwoven layer of fibers have a linear density in the range of 1 to 25 dtex, preferably in the range of 2 to 20 dtex, more preferably in the range of 5 to 15 dtex, most preferably in the range of 5 to 10 dtex to provide processing stability and mass regularity to the carrier while maintaining sufficient structure openness for even penetration of the PVC plastisol through the carrier. The unit dtex defines the fineness of the fibers as their weight in grams per 10000 meter.

The nonwoven layer of fibers comprised in the carrier may be any type of nonwoven, such as, for example staple fiber nonwovens produced by well-known processes, such as carding processes, wet-laid processes or air-laid processes or any combination thereof. The nonwoven layer of fibers may also be a nonwoven composed of filaments produced by well-known spunbonding processes, wherein filaments are extruded from a spinneret and subsequently laid down on a conveyor belt as a web of filaments and subsequently bonding the web to form a nonwoven layer of fibers, or by a two-step process, wherein filaments are spun and wound on bobbins, preferably in the form of multifilament yarns, followed by the step of unwinding the multifilament yarns and laying the filaments down on a conveyor belt as a web of filaments and bonding the web to form a nonwoven layer of fibers.

Preferably, the fibers in the nonwoven layer of fibers are filaments in order to provide higher tensile strength and/or higher tear strength to the carrier and/or to the vinyl floor covering.

The nonwoven layer of fibers may be composed of thermoplastic fibers for at least 50 wt. % of the total weight of fibers in the nonwoven layer of fibers, preferably for at least 75 wt. %, more preferably for at least 90 wt. %, even preferably for at least 95 wt. %. Increasing the amount of thermoplastic fibers in the nonwoven layer of fibers increases the tensile strength and/or tear resistance and increases the flexibility of the vinyl floor covering.

In an embodiment, the nonwoven layer of fibers is composed for 100 wt. % of thermoplastic fibers of the total weight of fibers in the nonwoven layer of fibers.

The thermoplastic polymer from which the thermoplastic fibers in the nonwoven layer of fibers are composed may be any type of thermoplastic polymer capable of withstanding the temperatures encountered in the vinyl floor covering manufacturing process. The thermoplastic fibers in the nonwoven layer of fibers may comprise a polyester, such as, for example, polyethylene terephthalate (PET) (based either on DMT or PTA), polybutylene terephthalate (PBT), polytrimethylene terephthalate (PTT), polyethylene naphthalate (PEN) and/or polylactic acid (PLA), a polyamide, such as for example polyamide-6 (PA6), polyamide-6,6 (PA6,6) and/or polyamide-6,10 (PA6,10), polyphenylenesulfide (PPS), polyethyleneimide (PEI) and/or polyoxymethylene (POM) and/or any copolymer or any blend thereof.

The thermoplastic fibers may comprise up to 26 wt. %, based on the total weight of the fibers, of additives, such as for example spinning auxiliaries, fillers, flame retardant materials, UV inhibitors, crystallization retarders/accelerators, plasticizers, heat stabilizers, antimicrobial additives, coloring agents such as for example carbon black or any combination thereof.

The weight of the nonwoven layer of fibers comprised in the carrier may be in the range of 40 g/m² to 250 g/m², preferably in the range of 45 g/m² to 200 g/m². preferably in the range of 50 g/m² to 150 g/m², more preferably in the range of 50 g/m² to 120 g/m², most preferably in the range of 60 g/m² to 100 g/m², to keep the structure of the carrier open enough for penetration of the impregnation layer of PVC plastisol, and to provide sufficient mechanical adhesion of the impregnation layer to the carrier. Lower weight of the nonwoven layer of fibers results in less consumption of PVC plastisol in the impregnation layer, but a too low weight of the nonwoven layer of fibers could result in PVC plastisol falling through the carrier before the PVC has been gelated into a coherent PVC material.

In an embodiment, the nonwoven layer of fibers, preferably composed of filaments, may be composed of a single type of mono-component fibers, which are bonded by any suitable bonding technique, such as, for example, by calendering the web of fibers between two calender rolls, by mechanical needling, by hydroentanglement, by ultrasonic bonding or by any combination thereof.

In another embodiment, the nonwoven layer of fibers, preferably composed of filaments, may comprise two types of mono-component fibers, each type of mono-component fibers being composed of a polymer of different chemical construction having a different melting point. It is preferred that the melting points of the two different polymers differ by at least 10° C. More preferably, the melting points differ by at least 50° C. Such a product could be thermally bonded by subjecting the web of fibers to a temperature in the range of the melting point of the polymer with the lower melting point.

In yet another embodiment, the nonwoven layer of fibers, preferably composed of filaments, may comprise bicomponent fibers. Bicomponent fibers are fibers composed of two polymers of different chemical construction. A basic distinction is being drawn between three types of bicomponent fibers: side-by-side types, core-sheath types and islands-in-the-sea types bicomponent fibers. In a preferred embodiment the meting points of the two polymers building the bicomponent fibers differ by at least 10° C. More preferably the melting points differ by at least 50° C. Such a nonwoven layer comprising bicomponent fibers, when composed of side-by-side types and/or core-sheath type bicomponent fibers, could be thermally bonded by subjecting the web of fibers to a temperature in the range of the melting point of the polymer with the lower melting point. In a preferred embodiment, the nonwoven carrier is predominantly made from core-sheath type bicomponent fibers, preferably filaments. Predominantly is understood to mean that at least 50% of the fibers comprised in the nonwoven layer of fibers are core-sheath type bicomponent fibers, preferably at least 75%, more preferably at least 90%, even more preferably at least 95%, most preferably 100%.

Preferably the core/sheath ratio in the core/sheath bicomponent fibers lies between 95/5 Vol. % and 5/95 Vol. %. More preferably the core/sheath ratio lies between 50/50 Vol. %. and 95/5 Vol. %.

In a preferred embodiment, the sheath of the core/sheath bicomponent fibers consists mainly of a polyamide, preferably polyamide-6 (PA6), and the core consists mainly of a polyester, preferably polyethylene terephthalate (PET).

In an embodiment, the carrier comprises a scrim wherein the weft threads of the scrim are configured to match the shrinkage in the cross machine direction of the nonwoven layer of fibers, in particular, when being subjected to the tensions in warp direction as encountered in the vinyl floor covering manufacturing process. Although it has been observed that a scrim comprising glass yarns both as warp and weft threads fully eliminated the formation of wrinkles extending in the machine direction in the vinyl floor covering, the scrim having glass yarns as weft threads may, depending on the actual tension and/or temperature encountered in the (cushioned) vinyl floor covering manufacturing process, induce surface irregularities in the final (cushioned) vinyl floor covering and/or may cause printing errors in the desired ink patterns applied onto the gelated foaming layer.

Surprisingly, it was found that a carrier comprising a nonwoven layer of fibers comprising thermoplastic fibers and a scrim having weft threads configured to match the shrinkage in the cross machine direction of the nonwoven layer of fibers, especially during gelation of the impregnation layer of PVC plastisol at elevated temperature, which is generally in the range of 140° C. to 170° C., prevents, or at least reduces, the formation of printing errors and prevents, or at least reduces, the formation of surface irregularities in the (cushioned) vinyl floor covering after foaming and curing of the PVC plastisol in the foaming and optionally In the backing layer.

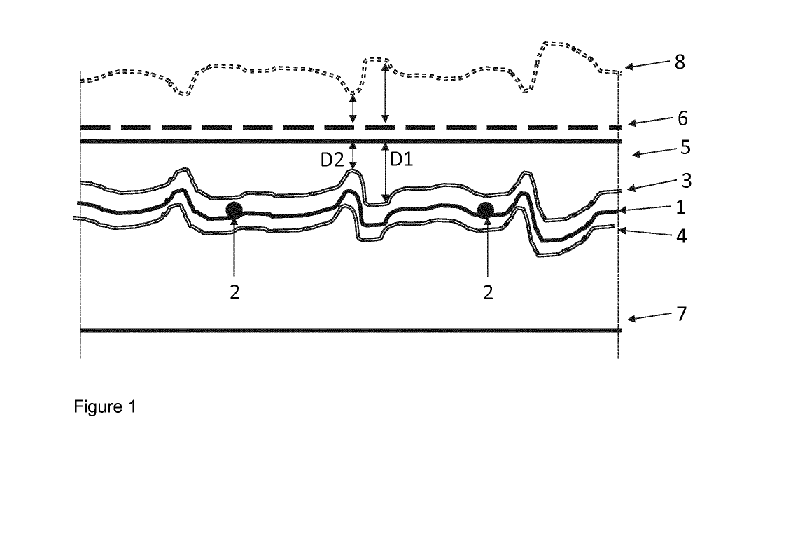

It is believed that the carrier comprising a scrim having weft threads configured to match the shrinkage in the cross machine direction of the nonwoven layer of fibers prevents buckling of the weft threads, i.e., bending or kinking of the weft threads as a result of compressive stress, when the nonwoven layer of fibers shrinks or contracts in the cross machine direction. Without being bound to this theory it is believed that buckling of the weft threads of the scrim during gelation of the PVC plastisol in the impregnation layer results in an uneven surface of the gelated impregnation layer, especially when buckling of the weft threads occurs out of the plane forming a surface of the carrier, as is schematically depicted in FIG. 1. A scrim comprises warp threads (2) and weft threads (1). The weft thread (1) has buckled during gelation of the impregnation layer of PVC plastisol. The impregnation layer has an irregular upper surface (3) and an irregular lower surface (4) due to buckling of the weft thread (1). Due to the uneven upper surface (3) of the gelated impregnation layer locally varying amounts, i.e., differences in layer thickness (D1, D2), of PVC plastisol will be coated on the irregular surface (3) of the gelated impregnation layer. In the case of cushioned vinyl floor coverings, the coating layer may still have a smooth, flat upper surface (5) directly after coating and after gelation of the PVC plastisol in the foaming layer. A desired ink pattern and a wear layer (6) may he applied on the surface (5) of the coated foaming layer. The locally varying amounts (D1, D2) of PVC plastisol comprising a blowing agent will induce surface irregularities in the surface (8) of the final cushioned vinyl floor covering after curing (foaming) of the foaming layer. At locations where a larger amount (D1) of PVC plastisol comprising a blowing agent is applied, the final thickness of the cushioned vinyl floor covering after foaming of the foaming layer will be higher than at locations where a smaller amount (D2) of PVC plastisol comprising a blowing agent is applied, resulting in surface irregularities in the surface (8) of the final cushioned vinyl floor covering.

Furthermore, it is believed that the uneven surfaces (3,4) of the gelated impregnation layer, due to buckling of the weft threads (1) of the scrim upon shrinkage or contraction in the cross machine direction of the nonwoven layer of fibers, complicates the local application of desired ink patterns on the gelated foaming layer (5). Although coating and subsequent gelation of the foaming layer may form an even surface (5) for the ink, it will be difficult to ensure application of an even pressure between the printing unit and the surface (5) of the gelated foaming layer over the surface to be printed, especially when the actual pressure is determined by the support provided by a supporting roller which is in direct contact with the opposite surface (4) of the irregular gelated impregnated layer. Finally, a backing layer (7) of foamable PVC plastisol is coated on the opposite surface (4) of the irregular gelated impregnated layer. Due to the uneven lower surface (4) of the gelated impregnation layer, locally varying amounts, i.e., differences, in layer thickness of PVC plastisol composing a blowing agent will also be applied as backing layer coated on the irregular surface (4) of the gelated impregnation layer. As the backing layer may be subjected to an embossing step, and the back side of the cushioned vinyl floor covering is not visible when installed on the floor, this effect may be of less importance.

Preferably, the scrim comprised in the carrier has a free shrinkage in the weft direction at a temperature in the range of 140° C. to 170° C. that differs at most by 1.00% from the free shrinkage in the cross machine direction of the nonwoven layer of fibers comprised in the carrier at the same temperature, more preferably differs at most by 0.50%, even more at most by 0.25%, even more preferably at most by 0.10% from the free shrinkage in the cross machine direction of the nonwoven layer of fibers to prevent buckling of the weft threads of the scrim. Most preferably, the scrim comprised in the carrier has a free shrinkage in the weft direction at a temperature in the range of 140° C. to 170° C. that is equal to the free shrinkage in the cross machine direction of the nonwoven layer of fibers comprised in the carrier at the same temperature.

The free shrinkage is determined by placing a sample of the scrim or a sample of the nonwoven layer of fibers, measuring 490 mm by 490 mm, in an oven at the particular temperature In the range of 140° C. to 170° C., preferably at a temperature of 150° C., for 1 minute, without applying a load to scrim, and measure the dimensions of the sample after cooling down to room temperature to determine the shrinkage in the weft direction of the scrim or in the cross machine direction of the nonwoven layer of fibers. The free shrinkage is to be determined as the average of five samples.

Preferably, the scrim comprised in the carrier has a shrinkage in weft direction at a temperature in the range of 140° C. to 170° C., while being subjected to a load in warp direction of 300 N/m, which differs at most by 1.00% from the shrinkage in the cross machine direction of the nonwoven layer of fibers comprised in the carrier at the same temperature, more preferably differs at most by 0.50%, even more at most by 0.25%, even more preferably at most by 0.10% from the shrinkage in the cross machine direction of the nonwoven layer of fibers to prevent buckling of the weft threads of the scrim. Most preferably, the scrim comprised in the carrier has a shrinkage In the weft direction at a temperature in the range of 140° C. to 170° C., while being subjected to a load in warp direction of 300 N/m, which Is equal to the shrinkage in the cross machine direction of the nonwoven layer of fibers comprised in the carrier, while being subjected to a load in warp direction of 300 N/m, at the same temperature.

The shrinkage of the scrim in weft direction, while being subjected to a load in warp direction of 300 N/m, is determined by applying a load of 300 N/m to a sample of the scrim or to a sample of the nonwoven layer of fibers, the sample measuring 7 m in length and 1 m in width and having an indicated measurement area of approx, 1 m×1 m marked on the sample. At least the indicated measurement area of the sample is introduced into an oven set to the particular temperature in the range of 140° C. to 170° C., preferably to a temperature of 150° C., for 1 minute, and the dimensions of the indicated measurement area on the sample are measured after cooling the sample down, while remaining under tension, to room temperature to determine the shrinkage in weft direction of the scrim or the shrinkage in the cross machine direction of the nonwoven layer of fibers. The shrinkage is to be determined as the average of three samples.

Preferably, the scrim comprised in the carrier has a shrinkage in weft direction, while being subjected to a load in warp direction of 300 N/m, at a temperature in the range of 140° C. to 170° C., preferably at a temperature of 150° C., which differs at most by 1.00% from the shrinkage in the cross machine direction of the nonwoven layer of fibers comprised in the carrier, while being subjected to a load in warp direction of 300 N/m, at the same temperature, more preferably differs at most by 0.50%, even more at most by 0.25%, even more preferably at most by 0.10% from the free shrinkage in the cross machine direction of the nonwoven layer of fibers to prevent buckling of the weft threads of the scrim. Most preferably, the scrim comprised in the carrier has a shrinkage in the weft direction, white being subjected to a load in warp direction of 300 N/m, at a temperature In the range of 140° C. to 170° C., preferably at a temperature of 150° C., which is equal to the shrinkage in the cross machine direction of the nonwoven layer of fibers comprised in the carrier, while being subjected to a load in warp direction of 300 N/m, at the same temperature.

When the scrim having weft threads configured to match the shrinkage in the cross machine direction of the nonwoven layer of fibers, is comprised in an Integrated carrier wherein the connection between the scrim and the-nonwoven layer of fibers is achieved by a process subjecting the scrim to an elevated temperature, such as, for example, by thermal bonding or by drying the carrier after hydroentanglement, the weft threads are preferably configured such that the shrinkage of the weft threads in the scrim matches the shrinkage in the cross machine direction of the nonwoven layer of fibers in the integrated carrier, after being subjected to the elevated temperature applied to obtain the integrated carrier.

In a preferred embodiment, the scrim having weft threads configured to match the shrinkage in the cross machine direction of the nonwoven layer of fibers comprises high modulus yarns as warp threads, such as, for example, glass yarns, aramid yarns or carbon yarns and/or other high modulus yarns, which are capable to withstand the temperatures encountered in the cushioned vinyl floor covering manufacturing process. Preferably, the scrim comprises glass yarns as warp threads, Preferably, all warp threads in the scrim are high modulus yarns, more preferably all warp threads in the scrim are glass yarns. The high modulus yarns may have a modulus of at least 25 GPa, preferably at least 40 GPa, more preferably at least 50 GPa, most preferably at least 75 GPa.

The type and amount of high modulus yarns comprised as warp threads in the scrim having weft threads configured to match the shrinkage in the cross machine direction of the nonwoven layer of fibers is selected such that the modulus of the scrim Is at least 50 N/5cm as determined as the load at specified elongation of 2% (LASE2%) In accordance with EN29073-3 (August 1992) with a clamp speed of 200 mm/min. Preferably, the modulus is at least 100 N/5 cm, more preferably at least 200 N/5 cm, most preferably at least 250 N/5 cm.

Preferably, the scrim in the carrier comprising weft threads is configured to match the shrinkage in the cross machine direction of the nonwoven layer of fibers in the carrier has a free shrinkage, at the particular temperature in the range of 140° C. to 170° C., preferably at a temperature of 150° C., and a residence time of 1 minute, of at least 0.10%, preferably at least 0.15%, more preferably at least 0.20%, even more preferably at least 0.25%, most preferably at least 0.30%.

Preferably, the scrim in the carrier comprising weft threads configured to match the shrinkage in the cross machine direction of the nonwoven layer of fibers in the carrier has a shrinkage, while being subjected to a load In warp direction of 300 N/m, at the particular temperature in the range of 140° C. to 170° C., preferably at a temperature of 150° C., and a residence time of 1 minute, of at least 0.10%, preferably at least 0.15%, more preferably at least 0.20%, most preferably at least 0.25%, most preferably at least 0.30%.

The weft threads in the scrim configured to match the shrinkage in the cross machine direction of the nonwoven layer of fibers may comprise any polymer suitable to withstand the temperatures encountered in the vinyl floor covering manufacturing process, to prevent the weft threads, and thus the scrim, from losing their structural shape. Preferably, the weft threads comprise a polymer having a melting point above the curing temperature applied to cure/foam the PVC plastisol in the front layer and/or In the backing layer, the polymer being preferably selected from a polyester, preferably polyethylene terephthalate (PET), polybutylene terephthalate (PBT), polytrimethylene terephthalate (PTT), polyethylene naphthalate (PEN) and/or polylactic acid (PLA), a polyamide, preferably polyamide-6 (PA6), polyamide-6,6 (PA6,6) and/or polyamide-6,10 (PA6,10), polyphenylonesulfide (PPS), polyethyleneimide (PEI) and/or polyoxymethylene (POM) and/or any copolymer or any blend thereof.

The degree of shrinkage of the weft threads in the scrim can be adjusted accordingly using well-known processes, such as, for example, multifilament yarn extrusion spinning processes wherein the shrinkage of the filament yarn can be influenced by selecting the processing conditions, such as, for example, the tension and/or the temperature, during extrusion of the polymer through spinning holes, during cooling of the extruded filaments and/or during drawing of the cooled filaments, or in a tape production process, by selecting the processing conditions, such as, for example, the tension and/or the temperature, wherein a sheet of polymer is formed by extrusion through a slit die or by a blown film process.

The carrier comprising a nonwoven layer of fibers comprising thermoplastic fibers and a scrim having weft threads configured to match the shrinkage in the cross machine direction of the nonwoven layer, of fibers is also suitable for other applications wherein the carrier is impregnated under tension and/or is subjected to elevated temperatures, such as, for example, the production of roofing membranes, especially for roofing membranes comprising a thin coating layer, preferably coated on the impregnation carrier, or the production of roofing underlayment sheets.

### EXAMPLES

### Example 1

A cushioned vinyl floor covering was produced based on a carrier comprising a nonwoven layer of fibers and a scrim. The nonwoven layer of fibers was composed of core-sheath bicomponent filaments having a fineness of 7.3 dtex, the core of the filaments being composed of polyethylene terephthalate and the sheath being composed of polyamide-6 in a ratio of 74/26 vol. %/vol. % and the nonwoven layer of fibers bad a weight 75 g/m². The scrim comprised 340 dtex glass yarns both in the machine direction and cross machine direction, the scrim having a construction of 1.3 glass yarns per cm in warp direction and 0.8 glass yarns per cm in weft direction. The scrim was embedded in the nonwoven layer of fibers. The filaments in the nonwoven layer of fibers were thermally bonded using hot air. The cushioned vinyl exhibited zero wrinkles in extending in the machine direction.

### Comparative Example

A cushioned vinyl floor covering was produced based on a carrier composed of a nonwoven layer of fibers. The nonwoven layer of fibers was composed of core-sheath bicomponent filaments having a fineness of 7.3 dtex, the core of the filaments being composed of polyethylene terephthalate and the sheath being composed of polyamide-6 in a ratio of 74/28 vol. %/vol. % and the nonwoven layer of fibers had a weight 75 g/m². The cushioned vinyl exhibited wrinkles in extending in the machine direction, especially near the side edges of the cushioned vinyl floor covering.

1. A vinyl floor covering comprising: a PVC plastisol impregnated into an integrated carrier, wherein the carrier comprises a nonwoven layer of fibers comprising thermoplastic fibers and a scrim, wherein the scrim and the nonwoven layer of fibers comprising thermoplastic fibers are connected to each other by mechanical and/or thermal bonding.

2. The vinyl floor covering according to claim 1 wherein the scrim comprises yarns as warp threads having a modulus of a least 25 GPa.

3. The vinyl floor covering according to claim 2 wherein the yarns comprised as warp threads in the scrim are selected such that the modulus of the scrim is at least 50 N/5 cm, as determined as a load at a specified elongation of 2% in accordance with EN29073-3 (August 1992) with a clamp speed of 200 mm/min.

4. The vinyl floor covering according to claim 1 wherein a shrinkage of the weft threads in the scrim matches the shrinkage in a cross machine direction of the nonwoven layer of fibers comprising thermoplastic fibers.

5. The vinyl floor covering according to claim 4 wherein the scrim comprised in the carrier has a free shrinkage in weft direction at a temperature in the range of 140° C. to 170° C., differs at most by 1%, from the free shrinkage in the cross machine direction of the nonwoven layer of fibers comprised in the carrier at the same temperature.

6. The vinyl floor covering according to any of claim 4 wherein the scrim has a free shrinkage, at a temperature of 150° C. and a residence time of 1 minute, of at least 0.1%.

7. The vinyl floor covering according to claim 3 wherein the modulus of the scrim is at least 100 N/5 cm, as determined as the load at specified elongation of 2% in accordance with EN29073-3 (August 1992) with a clamp speed of 200 mm/min.

8. The vinyl floor covering according to claim 3 wherein the modulus of the scrim is at least 200 N/5 cm, as determined as the load at specified elongation of 2% in accordance with EN29073-3 (August 1992) with a clamp speed of 200 mm/min.

9. The vinyl floor covering according to claim 3 wherein the modulus of the scrim is at least 250 N/5 cm, as determined as the load at specified elongation of 2% in accordance with EN29073-3 (August 1992) with a clamp speed of 200 mm/min.

10. The vinyl floor covering according to claim 5 wherein the modulus of the scrim is at least 250 N/5 cm, as determined as the load at specified elongation of 2% in accordance with EN29073-3 (August 1992) with a clamp speed of 200 mm/min.

11. The vinyl floor covering according to claim 5 wherein the free shrinkage differs at most by 0.5%.

12. The vinyl floor covering according to claim 5 wherein the free shrinkage differs at most by 0.25%.

13. The vinyl floor covering according to claim 5 wherein the free shrinkage differs at most by 0.1%.

14. The vinyl floor covering according to claim 1 wherein at least 50 wt. % of a total weight of fibers in the nonwoven layer of fibers are thermoplastic fibers.

15. The vinyl floor covering according to claim 1 wherein a weight of the nonwoven layer of fibers comprised in the carrier is in a range of 40 g/m² to 250 g/m².

16. The vinyl floor covering according to claim 1 wherein the scrim comprises glass yarns as warp threads and/or weft threads.

17. The vinyl floor covering according to claim 16 wherein both of the warp threads and the weft threads scrim comprise glass yarns.

18. The vinyl floor covering according to claim 6 wherein the free shrinkage is at least 0.15%.

19. The vinyl floor covering according to claim 6 wherein the free shrinkage is at least 0.2%.

20. The vinyl floor covering according to claim 6 wherein the free shrinkage is at least 0.25%.
